(19) United States
(12) Patent Application Publication
(10) Pub. No.: US 2019/0351545 A1
(43) Pub. Date: Nov. 21, 2019

(54) CLUSTER CONTROL METHOD, CLUSTER CONTROL SYSTEM, AND TERMINAL DEVICE

(71) Applicant: UBTECH ROBOTICS CORP., Shenzhen (CN)

(72) Inventors: Youjun XIONG, Shenzhen (CN); Ruohu YANG, Shenzhen (CN); Yidan WANG, Shenzhen (CN)

(21) Appl. No.: 16/231,945

(22) Filed: Dec. 25, 2018

(30) Foreign Application Priority Data
May 18, 2018 (CN) 201810480871.6

(51) Int. Cl. B25J 9/16

(52) U.S. Cl. CPC B25J 9/1602; B25J 9/1682

(57) ABSTRACT

A cluster control method, a cluster control system, and a terminal device are provided. The method includes: assigning, by a first control terminal, cluster identifications to itself and controlled terminals; sending, by the first control terminal, control instructions to corresponding controlled terminals and/or itself according to the assigned IDs when the first control terminal receives information feedbacked by all the controlled terminals and itself and denoting that ID assignments succeed, wherein the control instructions instruct the corresponding controlled terminals and/or itself to perform corresponding actions. Because the first control terminal sends control instructions to the controlled terminals and/or itself after receiving information feedbacked by the controlled terminals and itself and denoting that ID assignments succeed, and because when the first control terminal fails a second control terminal can update to be a first control terminal, effective and reliable communication between the control terminal and the controlled terminals may be ensured.

### CROSS-REFERENCE TO RELATED APPLICATION

This application claims priority to Chinese Patent Application No. 201810480871.6, filed on May 18, 2018, the contents of which are herein incorporated by reference in its entirety.

### TECHNICAL FIELD

The present disclosure belongs to the technical field of intelligent control, and more particularly, to a cluster control method, a cluster control system, and a terminal device.

### BACKGROUND

As robotic devices that perform work automatically, robots are widely used in all aspects of life. In a current robot operation process, it is often necessary to collectively control multiple robots at the same time. In order to meet this demand, generally the multiple robots are uniformly controlled through a host computer. Full-duplex communication is often used for data transmission between the host computer and each of the robots. It is proved that this communication manner can transmit data efficiently under normal use environment. However, there are certain restrictions on type of the data transmitted by this communication manner, and communication signal cannot be effectively transmitted when the communication signal is interfered.

### SUMMARY

The present embodiments provide a cluster control method, a cluster control system, and a terminal device, to solve the problem that communication signal cannot be effectively communicated when robots are under cluster control and communication signal is interfered.

In a first aspect, a cluster control method is provided. The cluster control method may include: assigning, by a first control terminal, cluster identifications (IDs) to itself and controlled terminals connected to the first control terminal, wherein the controlled terminals include at least two controlled terminals, and the controlled terminals include a second control terminal, the second control terminal is configured to, when the first control terminal fails, update to be a first control terminal; sending, by the first control terminal, control instructions to corresponding controlled terminals and/or the first control terminal itself according to the assigned IDs when the first control terminal receives information feedbacked by all the controlled terminals and itself and denoting that ID assignments succeed, wherein the control instructions are configured to instruct the corresponding controlled terminals and/or the first control terminal itself to perform corresponding actions.

In a second aspect, a cluster control system is provided. The cluster control system may include a processor and a memory, wherein the memory is configured to store computer instructions, the processor executes the computer instructions and is configured to: assign, by a first control terminal, cluster IDs to the first control terminal itself and controlled terminals connected to the first control terminal, wherein the controlled terminals include at least two controlled terminals, and the controlled terminals include a second control terminal, the second control terminal is configured to, when the first control terminal fails, update to be a first control terminal; send, by the first control terminal, control instructions to corresponding controlled terminals and/or the first control terminal itself according to the assigned IDs when the first control terminal receives information feedbacked by all the controlled terminals and itself and denoting that ID assignments succeed, wherein the control instructions are configured to instruct the corresponding controlled terminals and/or the first control terminal itself to perform corresponding actions.

In a third aspect, a terminal device is provided. The terminal device may include a memory, a processor, and a computer program stored in the memory and executable by the processor. The processor is configured to, when executes the computer program, implement operations in the cluster control method described above.

In a fourth aspect, a computer readable storage medium is provided. The computer readable storage medium stores a computer program, wherein the computer program is executed by a processor to implement operations in the cluster control method described above.

In the present embodiments, because the first control terminal sends control instructions to the controlled terminals after the first control terminal receives information feedbacked by the controlled terminals and denoting that ID assignments succeed, and because when the first control terminal fails the second control terminal can update to be a first control terminal, effective and reliable communication between the control terminal and the controlled terminals may be ensured.

### BRIEF DESCRIPTION OF THE DRAWINGS

In order to make the technical solution described in the embodiments of the present disclosure more clearly, the drawings used for the description of the embodiments will be briefly described. Apparently, the drawings described below are only for illustration but not for limitation. It should be understood that, one skilled in the art may acquire other drawings based on these drawings, without making any inventive work.

FIG. 1 is a schematic structure diagram of a system related to a cluster control method according to an embodiment of the present disclosure.

FIG. 2 is a schematic flowchart of a cluster control method according to an embodiment of the present disclosure.

FIG. 3 is a schematic flowchart showing an implementation of sending control instructions to corresponding controlled terminals according to assigned IDs provided in another embodiment of the present disclosure.

FIG. 4 is a schematic flowchart showing an implementation of sending control instructions to corresponding controlled terminals according to assigned IDs provided in another embodiment of the present disclosure.

FIG. 5 is a schematic flowchart showing an implementation of sending control instructions to corresponding controlled terminals according to assigned IDs provided in another embodiment of the present disclosure.

FIG. 6 is a schematic diagram of a cluster control system according to an embodiment of the present disclosure.

FIG. 7 is a schematic diagram of a terminal device according to an embodiment of the present disclosure.

### DETAILED DESCRIPTION

In the following description, for the purposes of illustration and not limitation, specific details such as specific system structures and specific technologies are proposed in order to thoroughly understand the present embodiments. However, it will be apparent to those skilled in the art that the present disclosure can be implemented in other embodiments without these specific details. In other instances, detailed descriptions of well-known systems, devices, circuits, and methods are omitted so as not to obscure the description of the present disclosure.

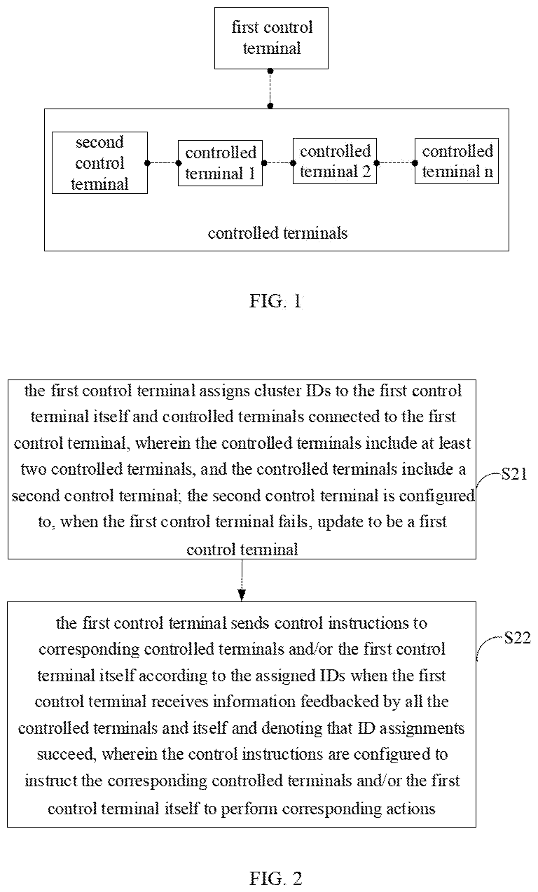

In a system related to a cluster control method according to an embodiment of the present disclosure, a first control terminal and a number of controlled terminals are included. The controlled terminals include a second control terminal (as shown in FIG. 1). The first control terminal may assign cluster IDs to itself and at least two controlled terminals connected to the first control terminal. The first control terminal may send control instructions to the first control terminal and/or the controlled terminals according to the assigned IDs when the first control terminal receives information feedbacked by itself and all the controlled terminals and denoting that ID assignments succeed, so that the first control terminal and/or the controlled terminals perform corresponding actions according to the received control instructions. Because the controlled terminals include a second control terminal, when the first control terminal fails the second control terminal may timely update to be a first control terminal.

In order to explain technical solutions described in the present disclosure, the following is explained by way of specific embodiments.

Referring to FIG. 2, a schematic flowchart of a cluster control method according to an embodiment of the present disclosure is shown. The method is described in details as follows.

In operation S21, the first control terminal assigns cluster IDs to the first control terminal itself and controlled terminals connected to the first control terminal, wherein the controlled terminals include at least two controlled terminals, and the controlled terminals include a second control terminal; the second control terminal is configured to, when the first control terminal fails, update to be a first control terminal.

In an embodiment, the first control terminal connects to a number of controlled terminals. When they are connected, data may be transmitted via WIFI 5G so as to reduce complexity of full-duplex communication and establish a unified communication standard.

After the first control terminal connects to the number of controlled terminals, the first control terminal sends a cluster ID group to all the controlled terminals and the first control terminal itself through multicast. When the cluster ID group is sent, an ID may be assigned to each of the controlled terminals according to a sequence in which the controlled terminals are connected to the first control terminal. The quantity of the controlled terminals may be determined according to information sent to the first control terminal by the controlled terminals when the controlled terminals access the cluster. The controlled terminals include a second control terminal, and when the first control terminal fails the second control terminal is configured to timely convert to be a first control terminal so as to continuously control other controlled terminals in the cluster.

For example, when the controlled terminals and the first control terminal are robots, the robot as the first control terminal (also referred as “first control-terminal robot”) assigns IDs to all the robots (including the first control-terminal robot itself) in the cluster.

In operation S22, the first control terminal sends control instructions to corresponding controlled terminals and/or the first control terminal itself according to the assigned IDs when the first control terminal receives information feedbacked by all the controlled terminals and itself and denoting that ID assignments succeed, wherein the control instructions are configured to instruct the corresponding controlled terminals to perform corresponding actions.

In an embodiment, when the cluster is composed of robots, the first control-terminal robot waits for feedbacks sent by all the controlled robots and denoting that ID assignments succeed and a feedback denoting that self-ID assignment succeeds. When the feedbacks of all the controlled robots and the first control-terminal robot itself are not completely received, the first control-terminal robot assigns IDs to all the controlled robots and itself again.

Further, after the IDs have been assigned to the robots, a newly joined robot needs to wait for a new ID assigned by the first control-terminal robot.

Optionally, in another embodiment provided by the present disclosure, the cluster control method may further include: receiving, by the first control terminal and all the controlled terminals, a join request of a terminal newly joining the cluster; and returning information that the request is successfully received to the terminal newly joining the cluster; indicating, by the first control terminal, the terminal newly joining the cluster to record physical addresses and cluster IDs of the controlled terminals in the cluster and physical address and cluster ID of the current first control terminal in the cluster after successfully joining the cluster.

When the cluster is composed of robots, the robots join the cluster and leave the cluster through a multicast protocol. The multicast address of the cluster is fixed as 225.0.1.11, and the port number is 20001. A robot needing to join the cluster sends a join request via voice or other events so as to join the 225.0.1.11 multicast.

After joining a multicast group, the robot sends Hello multicast packet to other robots. After receiving the Hello multicast packet, the other robots should respond the robot that sends the Hello multicast packet in a manner of unicast. The newly joined robot records Mac addresses, cluster IDs and other information of other robots (i.e., the robot as first control terminal and the robots as controlled terminals) in the cluster.

Optionally, in another embodiment provided by the present disclosure, the cluster control method may further include: receiving an election activity initiated by a terminal newly joining the cluster, selecting a first control terminal of the current moment according to the election activity, adjusting the original first control terminal to be the second control terminal of the current moment, and adjusting the original second control terminal to be a controlled terminal.

In this operation, the terminal newly joining the cluster initiates the election activity, the first control terminal of the current moment is selected according to the priorities of all the terminals in the cluster; then the original first control terminal is converted to a second control terminal, and the priority thereof is adjusted. The original second control terminal is converted to a controlled terminal and its priority is adjusted.

Take the cluster of robots as an example. After a new robot joins the cluster, its priority is set to be 255. A larger value of the priority indicates a lower priority. The newly joining robot initiates an election activity and sends a corresponding information to all other robots in the cluster. A robot with a small priority directly becomes the first control terminal of the current moment. When there are two or more robots with the smallest priority in the cluster, their Mac addresses are compared. A robot with a small Mac address becomes the first control terminal of the current moment. The value of the priority of a first control terminal robot is reduced by 20; the first control terminal robot sends an election completion information (including MAC address, cluster ID, priority) to other robots, and other robots update information of the new first control terminal robot. At the same time, the original first control terminal robot becomes a new second control terminal robot with a priority increased by 10, and sends a second control terminal election completion information. The identity of the original second end robot is canceled, the priority of the original second end robot is increased by 10 (the maximum robot priority is 255), the original second end robot becomes a normal robot and does not send information. For new robots joined later, an election activity is required to be initiated once a new robot is joined. Each new first control terminal robot needs to send an election completion information to other robots via multicast.

Optionally, in another embodiment provided by the present disclosure, the cluster control method may further include: periodically sending, by the first control terminal, valid status information to the second control terminal, and receiving, by the first control terminal, status feedback information sent by the second control terminal, wherein the valid status information is used to identify that the first control terminal is currently in a valid working status; when the first control terminal does not send the valid status information to the second control terminal within a first preset time period, updating the second control terminal to be a first control terminal; when the first control terminal does not receive the status feedback information sent by the second control terminal within a second preset time period, initiating an election activity for electing a second control terminal.

In this operation, the elected first control terminal periodically sends the valid status information to the second control terminal to inform the second control terminal that the first control terminal is in a valid status; meanwhile, after receiving the valid status information, the second control terminal end periodically sends the status feedback information to the first control terminal to inform the first control terminal that the second control terminal is also in a normal working status. When the second control terminal does not receive the valid status information within the first preset time period (this indicates that the first control terminal may not work normally), updating the second control terminal to be a first control terminal. For the same reason, when the first control terminal does not receive the status feedback information sent by the second control terminal within the second preset time period, initiating an election activity for electing a second control terminal to generate a new second control terminal.

Taking the cluster of robots as an example. The first control terminal robot sends a Keepalive information (via unicast) to the second control terminal robot every 1 second. When the second control terminal robot does not receive the Keepalive information after 3 seconds, the second control terminal robot is switched to be a first control terminal robot of the current moment, with a priority reduced by 10, and sends an election completion information to other robots (via multicast transmission). Other robots update the new first control terminal robot. When the first control terminal robot does not receive the Keepalive feedback from the second control terminal robot within 3 seconds, this indicates that the second control terminal robot may not be working. At this time, an election for a new second control terminal robot is required to be initiated, and the generated new second control terminal robot has a priority reduced by 10.

Optionally, in another embodiment provided by the present disclosure, before the first control terminal sends control instructions to corresponding controlled terminals according to the assigned IDs, the cluster control method may include: synchronizing the time of each controlled terminal with the time of the first control terminal by using a network time synchronization protocol.

In an embodiment provided by the present disclosure, the time of each terminal (i.e., the first control terminal and the controlled terminals) in the cluster is synchronized by the NTP protocol to ensure that the time of each terminal is consistent.

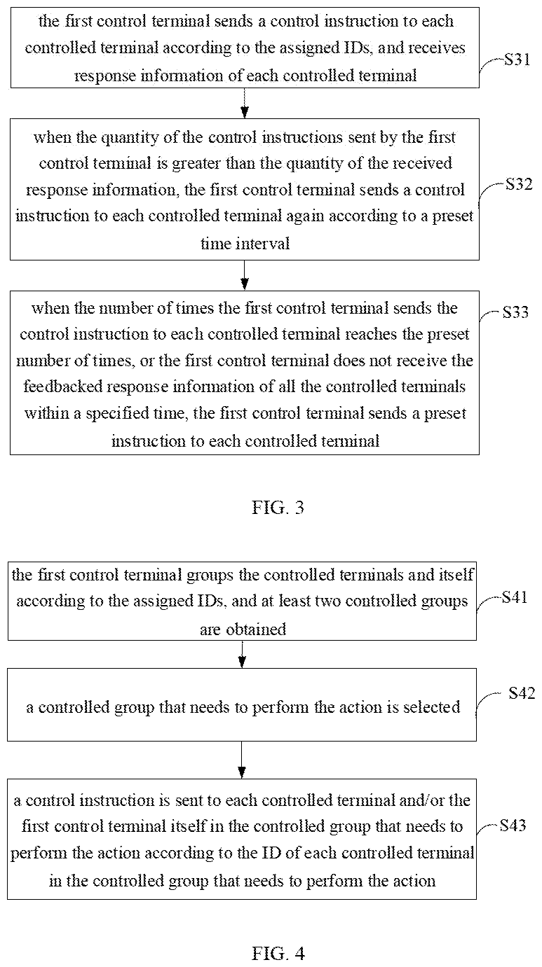

In another embodiment of the present disclosure shown in FIG. 3, sending control instructions to corresponding controlled terminals according to assigned IDs may include the following operations.

In operation S31, the first control terminal sends a control instruction to each controlled terminal according to the assigned IDs, and receives response information of each controlled terminal.

In this operation, when the first control terminal needs to control all the controlled terminals to perform action together with itself, the first control terminal sends a control instruction to each controlled terminal (the control instruction may be stored in the first control terminal, so that the first control terminal and all the control terminals execute the control instruction together) and waits to receive a response information from each controlled terminal.

In operation S32, when the quantity of the control instructions sent by the first control terminal is greater than the quantity of the received response information, the first control terminal sends a control instruction to each controlled terminal again according to a preset time interval.

In this operation, the first control terminal monitors and counts the quantity of feedbacked response information of the controlled terminals to the control instruction. When the quantity of the sent control instructions is greater than the quantity of the response information, the first control terminal sends the control instruction to all controlled terminals again at regular intervals within a preset number of times.

In operation S33, when the number of times the first control terminal sends the control instruction to each controlled terminal reaches the preset number of times, or the first control terminal does not receive the feedbacked response information of all the controlled terminals within a specified time, the first control terminal sends a preset instruction to each controlled terminal.

In this operation, determining, according to the recorded number of times the first control terminal repeatedly sends the control instruction, whether the number of times the first control terminal sends the control instruction reaches the preset number of times. If so, and when the quantity of response information received by the first control terminal is still less than the quantity of control instructions sent by the first control terminal, or the feedbacked response information of all the controlled terminals are not received within a specified time period, an instruction to cancel the control instruction is sent at a certain time within a time period set by the user, while waiting feedback information of the controlled terminals. When receiving feedbacks from all the controlled terminals to the instruction for cancelling the control instruction, proceeding to control each controlled terminal to execute the control instruction; otherwise, sending the preset instruction to each controlled terminal to instruct the controlled terminal receiving the preset instruction to perform action of the preset instruction, and checking whether the connection between the controlled terminal that does not execute the preset instruction and the first control terminal is normal, or checking other problem. The preset instruction may include a squat instruction.

For example, each terminal in the robot cluster synchronizes time through the NTP protocol so as to ensure that the time of all robots is consistent. The first control-terminal robot sends a control instruction including a name for performing a specific action, a specified time for executing the action, and a serial number to the controlled terminals, wherein the specified time is the current time of the first control terminal robot increased by 15s.

After receiving the control instruction, the robot as the controlled terminal subtracts its current time from the specified time for performing the action in the packet, and starts the timer to perform the specific action. Also, the robot as the controlled terminal sends response information to the first control-terminal robot. When the first control-terminal robot receives the response information of all the robots as the controlled terminals, information is no longer sent, and the action is waited to start.

When the first control-terminal robot does not receive the response information of all the robots as the control-terminal (also referred as control-terminal robots), the control instruction is sent every 1 s. When the response information of all control-terminal robots has not been received in the 5th second, information for cancelling the control instruction is sent every 1 s until the end of the 10th second. When feedbacks of all the control-terminal robots to the information for cancelling the control instruction are received, the action in the control instruction is re-executed. Otherwise, an instruction of collective squat action is sent to all control-terminal robots, and the delay is set to be 0 s. The robots that can receive the packet squat, and the standing robots are manually checked to determine whether an unsuccessful network connection or the like is existed.

In another embodiment of the present disclosure shown in FIG. 4, sending control instructions to corresponding controlled terminals and/or the first control terminal itself according to assigned IDs may further include the following operations.

In operation S41, the first control terminal groups the controlled terminals and itself according to the assigned IDs, and at least two controlled groups are obtained.

In this operation, when a part of the controlled terminals needs to perform a specific action at the same time, the controlled terminals are grouped according to IDs of the controlled terminals and/or itself, and multiple controlled groups are obtained.

In operation S42, a controlled group that needs to perform the action is selected.

In operation S43, a control instruction is sent to each controlled terminal and/or the first control terminal itself in the controlled group that needs to perform the action according to the ID of each controlled terminal in the controlled group that needs to perform the action.

In this operation, the control instruction is sent to the selected controlled group to indicate that the controlled terminals in the controlled group to perform corresponding actions. The above controlled group is obtained from grouping, by the first control terminal, all the terminals in the cluster according to the needs of the action execution.

For example, after synchronizing time in the robot cluster through the NTP protocol, the time of all the robots is guaranteed to be consistent. The first control-end robot sends a control instruction to the robots in the selected controlled group via multicast information. The control instruction may include a name for performing a specific action, a specified time for executing the action, and a serial number.

After receiving the control instruction, the robot in the selected controlled group subtracts its current time from the specified time for performing the action in the packet, and starts the timer to perform the action in the control instruction. After the robot with the cluster ID of 1 (or other ID) performs the action, the packet of action execution completion is sent through the multicast. The packet includes the cluster ID.

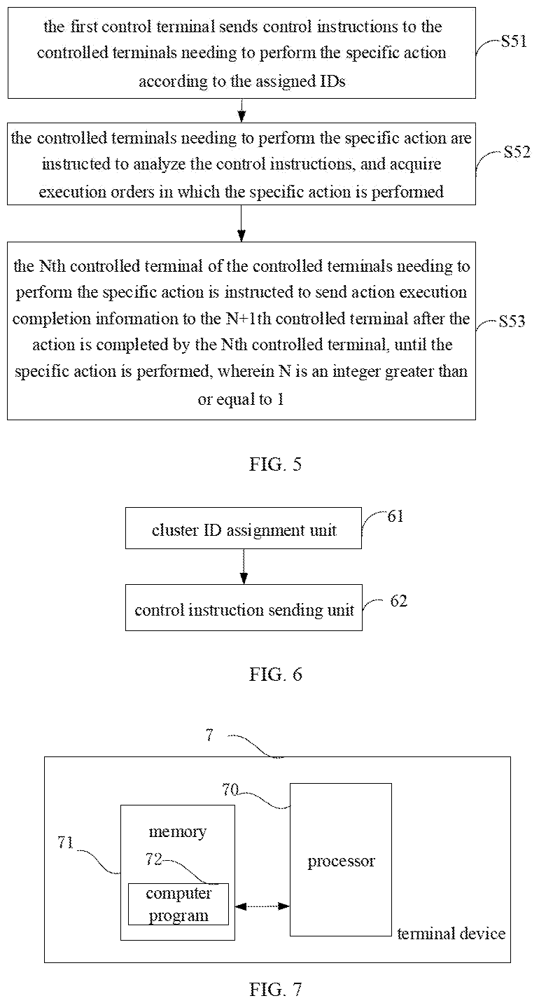

In another embodiment of the present disclosure shown in FIG. 5, sending control instructions to corresponding controlled terminals according to assigned IDs may further include the following operations.

In operation S51, the first control terminal sends control instructions to the controlled terminals needing to perform the specific action according to the assigned IDs.

In this operation, the first control terminal selects the controlled terminals that need to perform the specific action, and respectively sends control instructions containing action that needs to be performed to the selected controlled terminals.

In operation S52, the controlled terminals needing to perform the specific action are instructed to analyze the control instructions, and acquire execution orders in which the specific action is performed.

In this operation, the controlled terminal receiving the control instructions analyzes the control instructions to obtain an action that needs to be performed and an order in which the action is performed.

In operation S53, the Nth controlled terminal of the controlled terminals needing to perform the specific action is instructed to send action execution completion information to the N+1th controlled terminal after the action is completed by the Nth controlled terminal, until the specific action is performed, wherein N is an integer greater than or equal to 1.

In this operation, the controlled terminal performs the corresponding actions according to the action that needs to perform and the execution sequence. Specifically, the controlled terminal in the execution sequence of 1 first performs its action, and after the action is completed sends the execution completion information to the controlled terminal in the execution sequence of 2. The controlled terminal in the execution sequence of 2 starts to perform the corresponding actions after receiving the execution completion information, and so on, until the specific action is performed.

For example, each terminal in the robot cluster synchronizes time through the NTP protocol to ensure that the time of all robots is consistent. The first control-terminal robot sends a control instruction including a name for performing a specific action, a specified time for executing the action, and a serial number to the control-terminal robot. After receiving the control instruction, the control-terminal robot subtracts its current time from the specified time for performing the action in the packet, and starts the timer to perform the specific action. When the order in which the control-terminal robot performs the action is the order of its ID, the robot with the cluster ID of 1 performs the action, and the packet of action execution completion is sent through multicast after the action is performed. The packet includes the cluster ID. When the robot with the cluster ID of 2 receives the packet of action execution completion from the robot with the cluster ID of 1, it starts to perform the new action. And so on, until the last robot performs the action.

In the system formed by the cluster control method according to an embodiment of the present disclosure, a first control terminal and a number of controlled terminals are included. The controlled terminals include a second control terminal (as shown in FIG. 1). The first control terminal may assign cluster IDs to itself and at least two controlled terminals connected to the first control terminal. The first control terminal may send control instructions to the first control terminal and/or the controlled terminals according to the assigned IDs when the first control terminal receives information feedbacked by itself and all the controlled terminals and denoting that ID assignments succeed, so that the first control terminal and/or the controlled terminals perform corresponding actions according to the received control instructions. Because the controlled terminals include a second control terminal, when the first control terminal fails the second control terminal may timely update to be a first control terminal. In the present embodiments, because the first control terminal sends control instructions to the controlled terminals after the first control terminal receives information feedbacked by the controlled terminals and denoting that ID assignments succeed, and when the first control terminal fails the second control terminal can timely update to be a first control terminal, effective and reliable communication between the control terminal and the controlled terminals may be ensured.

Corresponding to the cluster control method described in the foregoing embodiments, FIG. 6 shows a structural block diagram of a cluster control system according to an embodiment of the present disclosure. For convenience of description, only parts related to the embodiment of the present disclosure are shown.

Referring to FIG. 6, the cluster control system may include a cluster ID assignment unit 61 and a control instruction sending unit 62.

The cluster ID assignment unit 61 is configured to assign, by the first control terminal, the cluster IDs to itself and the controlled terminals connected to the first control terminal, wherein the controlled terminals include at least two controlled terminals, and the controlled terminals include the second control terminal, the second control terminal is configured to, when the first control terminal fails, update to be a first control terminal.

The control instruction sending unit 62 is configured to send, by the first control terminal, the control instructions to corresponding controlled terminals and/or the first control terminal itself according to the assigned IDs when the first control terminal receives information feedbacked by all the controlled terminals and itself and denoting that ID assignments succeed, wherein the control instructions are configured to instruct the corresponding controlled terminals and/or the first control terminal itself to perform corresponding actions.

Further, the control instruction sending unit 62 is configured to: send, by the first control terminal, a control instruction to each controlled terminal according to the assigned IDs, and receives response information of each controlled terminal; send, by the first control terminal, a control instruction to each controlled terminal again according to a preset time interval when the quantity of the control instructions sent by the first control terminal is greater than the quantity of the received response information; send, by the first control terminal, a preset instruction to each controlled terminal when the number of times the first control terminal sends the control instruction to each controlled terminal reaches the preset number of times, or the first control terminal does not receive the feedbacked response information of all the controlled terminals within a specified time.

Further, the control instruction sending unit 62 is configured to: group, by the first control terminal, the controlled terminals and itself according to the assigned IDs, to obtain at least two controlled groups; select a controlled group that needs to perform the action; send a control instruction to each controlled terminal and/or itself in the controlled group in which the action needs to be performed according to the ID of each controlled terminal in the controlled group that needs to perform the action and/or the ID of itself.

Further, the control instruction sending unit 62 is configured to: send, by the first control terminal, control instructions to the controlled terminals needing to perform the specific action according to the assigned IDs; instruct the controlled terminals needing to perform the specific action to analyze the control instructions, and acquire execution orders in which the specific action is performed; instruct the Nth controlled terminal of the controlled terminals needing to perform the specific action to send action execution completion information to the N+1th controlled terminal after the action is completed by the Nth controlled terminal, until the specific action is performed, wherein N is an integer greater than or equal to 1.

Further, the cluster control system may include an adjustment unit configured to synchronize the time of each controlled terminal with the time of the first control terminal using a network time synchronization protocol.

Further, the cluster control system may include an election unit. The election unit is configured to: receive an election activity initiated by a terminal newly joined to the cluster, select a first control terminal of the current moment according to the election activity; adjust the original first control terminal to be a second control terminal of the current moment, and adjust the original second control terminal to be a controlled terminal.

Further, the cluster control system may include a validity detection unit. The validity detection unit is configured to: periodically send, by the first control terminal, valid status information to the second control terminal, and receive, by the first control terminal, status feedback information sent by the second control terminal, wherein the valid status information is used to identify that the first control terminal is currently in a valid working status; when the first control terminal does not send the valid status information to the second control terminal within a first preset time period, update the second control terminal to be a first control terminal; when the first control terminal does not receive the status feedback information sent by the second control terminal within a second preset time period, initiate an election activity for electing a second control terminal.

It should be understood that, the level of the sequence numbers of the operations in the foregoing embodiments does not mean the order of execution, and the order of execution of each process should be determined by its function and internal logic, and should not constitute any limitation on the implementation process of the embodiments of the present disclosure.

FIG. 7 shows a schematic diagram of a terminal device according to an embodiment of the present disclosure. As shown in FIG. 7, the terminal device 7 may include a processor 70, a memory 71, and a computer program 72 stored in the memory 71 and executable by the processor 70. The processor 70 executes the computer program 71 and is configured to implement operations (e.g., the operations S21 to S22 shown in FIG. 2) in each of the cluster control methods described above. Alternatively, when the processor 70 executes the computer program 72, the functions of the modules/units in the foregoing device embodiments are implemented, such as the functions of the modules 61 to 62 shown in FIG. 6.

For example, the computer program 72 can be partitioned into one or more modules/units that are stored in the memory 71 and executed by the processor 70 to complete the present disclosure. The one or more modules/units may be a series of computer program instruction segments capable of performing a particular function, the instruction segments are used to describe the process of the computer program 72 performed in the terminal device 7. For example, the computer program 72 can be divided into a cluster IDs assigning unit 71 and a control instruction sending unit 72.

The cluster ID assignment unit is configured to assign, by the first control terminal, the cluster IDs to itself and the controlled terminals connected to the first control terminal, wherein the controlled terminals include at least two controlled terminals, and the controlled terminals include the second control terminal, the second control terminal is configured to, when the first control terminal fails, update to be a first control terminal.

The control instruction sending unit is configured to send, by the first control terminal, the control instructions to corresponding controlled terminals and/or the first control terminal itself according to the assigned IDs when the first control terminal receives information feedbacked by all the controlled terminals and itself and denoting that ID assignments succeed, wherein the control instructions are configured to instruct the corresponding controlled terminals and/or the first control terminal itself to perform corresponding actions.

Further, the control instruction sending unit is configured to: send, by the first control terminal, a control instruction to each controlled terminal according to the assigned IDs, and receives response information of each controlled terminal; send, by the first control terminal, a control instruction to each controlled terminal again according to a preset time interval when the quantity of the control instructions sent by the first control terminal is greater than the quantity of the received response information; send, by the first control terminal, a preset instruction to each controlled terminal when the number of times the first control terminal sends the control instruction to each controlled terminal reaches the preset number of times, or the first control terminal does not receive the feedbacked response information of all the controlled terminals within a specified time.

Further, the control instruction sending unit is configured to: group, by the first control terminal, the controlled terminals and itself according to the assigned IDs, to obtain at least two controlled groups; select a controlled group that needs to perform the action; send a control instruction to each controlled terminal and/or itself in the controlled group in which the action needs to be performed according to the ID of each controlled terminal in the controlled group that needs to perform the action and/or the ID of itself.

Further, the control instruction sending unit is configured to: send, by the first control terminal, control instructions to the controlled terminals needing to perform the specific action according to the assigned IDs; instruct the controlled terminals needing to perform the specific action to analyze the control instructions, and acquire execution orders in which the specific action is performed; instruct the Nth controlled terminal of the controlled terminals needing to perform the specific action to send action execution completion information to the N+1th controlled terminal after the action is completed by the Nth controlled terminal, until the specific action is performed, wherein N is an integer greater than or equal to 1.

Further, the cluster control system may include an adjustment unit configured to synchronize the time of each controlled terminal with the time of the first control terminal using a network time synchronization protocol.

Further, the cluster control system may include an election unit. The election unit is configured to: receive an election activity initiated by a terminal newly joined to the cluster, select a first control terminal of the current moment according to the election activity; adjust the original first control terminal to be a second control terminal of the current moment, and adjust the original second control terminal to be a controlled terminal.

Further, the cluster control system may include a validity detection unit. The validity detection unit is configured to: periodically send, by the first control terminal, valid status information to the second control terminal, and receive, by the first control terminal, status feedback information sent by the second control terminal, wherein the valid status information is used to identify that the first control terminal is currently in a valid working status; when the first control terminal does not send the valid status information to the second control terminal within a first preset time period, update the second control terminal to be a first control terminal; when the first control terminal does not receive the status feedback information sent by the second control terminal within a second preset time period, initiate an election activity for electing a second control terminal.

The terminal device 7 may be a computing device such as a desktop computer, a notebook, a palmtop computer, an intelligent robot, etc. The terminal device 7 may include, but is not limited to, a processor 70 and a memory 71. It will be understood by those skilled in the art that, FIG. 7 shows merely an example of the terminal device 7, and does not constitute a limitation of the terminal device 7, and may include more or less components than those illustrated, or combine some components, or different components. For example, the terminal device 7 may further include an input/output device, a network access device, a bus, and the like.

The processor 70 may be a central processing unit (CPU), or may be other general-purpose processors, a digital signal processor (DSP), an application specific integrated circuit (ASIC), field-programmable gate array (FPGA) or other programmable logic device, discrete gate or transistor logic device, discrete hardware components, etc. The general-purpose processor may be a microprocessor. Alternatively, the processor may also be any conventional processor, etc.

The memory 71 may be an internal storage unit of the terminal device 7, such as a hard disk or a memory of the terminal device 7. The memory 71 may also be an external storage device of the terminal device 7, for example, a plug-in hard disk equipped on the terminal device 7, a smart memory card (SMC), a secure digital (SD) card, a flash card, etc. Further, the memory 71 may also include both an internal storage unit of the terminal device 7 and an external storage device. The memory 71 is used to store the computer program and other programs and data required by the terminal device. The memory 71 can also be used to temporarily store data that has been output or is about to be output.

It will be clearly understood by those skilled in the art that, for convenience and brevity of description, only the division of each functional unit and module described above is exemplified. In practical applications, the above functions may be assigned to different functional units and modules according to the needs, i.e., dividing the internal structure of the device into different functional units or modules to perform all or part of the functions described above. Each functional unit and module in the embodiment may be integrated into one processing unit, or each unit may exist alone physically, or two or more units may be integrated into one unit, and the integrated unit may be implemented by hardware or in the form of software functional units. In addition, specific names of respective functional units and modules are only for the purpose of facilitating mutual differentiation, and are not intended to limit the scope of protection of the present disclosure. For the specific working process of the unit and the module in the foregoing system, reference may be made to the corresponding process in the foregoing method embodiments, and details are not described herein again.

In the above embodiments, the descriptions of the various embodiments are different, and the parts that are not detailed or described in a certain embodiment can be referred to the related descriptions of other embodiments.

Those of ordinary skill in the art will appreciate that, the elements and algorithm steps of the various examples described in connection with the embodiments disclosed herein can be implemented in electronic hardware or a combination of computer software and electronic hardware. Whether these functions are performed in hardware or software depends on the specific application and design constraints of the technical solution. A person skilled in the art can use different methods for implementing the described functions for each particular application, but such implementation should not be considered to be beyond the scope of the present disclosure.

In the embodiments provided by the present disclosure, it should be understood that the disclosed apparatus/terminal device and method may be implemented in other manners. For example, the apparatus/terminal device embodiment described above is merely illustrative. For example, the division of the module or unit is only a logical function division. In actual implementation, there may be another division manner; for example, multiple units or components may be combined or integrated into another system, or some features may be omitted or not implemented. In addition, the coupling or communication connection between components shown or discussed herein may be an indirect coupling or communication connection through some interface, device or unit, and may be electrical, mechanical or otherwise.

The units described as separate parts may or may not be physically separated, and the parts shown as units may or may not be physical units, that is, may be located in one position, or may also be distributed on a plurality of network units. A part of or all of the units may be selected according to actual needs to achieve the objectives of the solutions of the embodiments.

In addition, functional units in the embodiments of the present disclosure may be integrated into one processing unit, or each of the units may exist alone physically, or two or more units may be integrated into one unit. The above integrated unit may be implemented in the form of hardware or in the form of a software functional unit.

When the integrated module/unit is implemented in the form of a software functional unit and sold or used as an independent product, the integrated module/unit may be stored in a computer-readable storage medium. Based on such an understanding, all or part of the processes in the method for implementing the above embodiments may also be implemented by instructing related hardware using a computer program. The computer program may be stored in a computer readable storage medium. The computer program, when executed by the processor, can implement the steps of the foregoing various method embodiments. The computer program includes computer program code, and the computer program code can be in the form of source code, object code, and executable file, or some intermediate form, etc. The computer readable storage medium may include any entity or device capable of carrying the computer program code, a recording medium, a USB flash disk, a removable hard disk, a magnetic disk, an optical disk, a computer memory, a read-only memory (ROM), a random-access memory (RAM), electrical carrier signals, telecommunications signals, and software distribution media, etc. It should be noted that, the content contained in the computer readable medium may be appropriately increased or decreased according to the requirements of legislation and patent practice in a jurisdiction, for example, in some jurisdictions, according to legislation and patent practice, computer readable media does not include electrical carrier signals and telecommunication signals.

The foregoing descriptions are merely specific implementation manners of the present application, but are not intended to limit the protection scope of the present application. Any variation or replacement readily figured out by a person skilled in the art within the technical scope disclosed in the present application shall fall within the protection scope of the present application. Therefore, the protection scope of the present application shall be subject to the protection scope of the claims.

What is claimed is:

1. A cluster control method, comprising:
assigning, by a first control terminal, cluster IDs to itself and controlled terminals connected to the first control terminal, wherein the controlled terminals comprise at least two controlled terminals, and the controlled terminals comprise a second control terminal; the second control terminal is configured to, when the first control terminal fails, update to be a first control terminal; and
sending, by the first control terminal, control instructions to corresponding controlled terminals and/or itself according to the assigned IDs when the first control terminal receives information feedbacked by all the controlled terminals and itself and denoting that ID assignments succeed, wherein the control instructions are configured to instruct the corresponding controlled terminals and/or the first control terminal itself to perform corresponding actions.

2. The cluster control method according to claim 1, wherein sending control instructions to corresponding controlled terminals according to the assigned IDs comprises:
sending, by the first control terminal, a control instruction to each controlled terminal according to the assigned IDs, and receiving, by the first control terminal, response information of each controlled terminal;
when the quantity of the control instructions sent by the first control terminal is greater than the quantity of the received response information, sending, by the first control terminal, a control instruction to each controlled terminal again according to a preset time interval; and
when the number of times the first control terminal sends the control instruction to each controlled terminal reaches the preset number of times, or the first control terminal does not receive the feedbacked response information of all the controlled terminals within a specified time, sending, by the first control terminal, a preset instruction to each controlled terminal.

3. The cluster control method according to claim 1, wherein sending control instructions to corresponding controlled terminals and/or itself according to the assigned IDs further comprises:
grouping, by the first control terminal, the controlled terminals and itself according to the assigned IDs, and obtaining at least two controlled groups;
selecting a controlled group that needs to perform the action; and
sending a control instruction to each controlled terminal and/or the first control terminal itself in the controlled group that needs to perform the action according to the ID of each controlled terminal and/or the first control terminal itself in the controlled group that needs to perform the action.

4. The cluster control method according to claim 1, wherein sending control instructions to corresponding controlled terminals according to the assigned IDs further comprises:
sending, by the first control terminal, control instructions to the controlled terminals needing to perform specific action according to the assigned IDs;
instructing the controlled terminals needing to perform the specific action to analyze the control instructions, and acquire execution orders in which the specific action is performed; and
instructing the Nth controlled terminal of the controlled terminals needing to perform the specific action to send action execution completion information to the N+1th controlled terminal after the action is completed by the Nth controlled terminal, until the specific action is performed, wherein N is an integer greater than or equal to 1.

5. The cluster control method according to claim 1, wherein before sending control instructions to corresponding controlled terminals according to the assigned IDs, the cluster control method comprises:
synchronizing the time of each controlled terminal with the time of the first control terminal by using a network time synchronization protocol.

6. The cluster control method according to claim 1, wherein the cluster control method further comprises:
receiving an election activity initiated by a terminal newly joined to the cluster, selecting a first control terminal of current moment according to the election activity, and
adjusting the original first control terminal to be a second control terminal of the current moment, and adjusting the original second control terminal to be a controlled terminal.

7. The cluster control method according to claim 1, wherein the cluster control method further comprises:
periodically sending, by the first control terminal, valid status information to the second control terminal, and receiving, by the first control terminal, status feedback information sent by the second control terminal; wherein the valid status information is used to identify that the first control terminal is currently in a valid working status,
when the first control terminal does not send the valid status information to the second control terminal within a first preset time period, updating the second control terminal to be a first control terminal; and
when the first control terminal does not receive the status feedback information sent by the second control terminal within a second preset time period, initiating an election activity for electing a second control terminal.

8. A cluster control system, comprising a processor and a memory, wherein the memory is configured to store computer instructions, the processor executes the computer instructions and is configured to:
assign, by a first control terminal, cluster IDs to the first control terminal itself and controlled terminals connected to the first control terminal, wherein the controlled terminals include at least two controlled terminals, and the controlled terminals include a second control terminal; the second control terminal is configured to, when the first control terminal fails, update to be a first control terminal; and
send, by the first control terminal, control instructions to corresponding controlled terminals and/or the first control terminal itself according to the assigned IDs when the first control terminal receives information feedbacked by all the controlled terminals and itself and denoting that ID assignments succeed, wherein the control instructions are configured to instruct the corresponding controlled terminals and/or the first control terminal itself to perform corresponding actions.

9. The cluster control system according to claim 8, wherein sending control instructions to corresponding controlled terminals according to the assigned IDs comprises:
sending, by the first control terminal, a control instruction to each controlled terminal according to the assigned IDs, and receiving, by the first control terminal, response information of each controlled terminal;
when the quantity of the control instructions sent by the first control terminal is greater than the quantity of the received response information, sending, by the first control terminal, a control instruction to each controlled terminal again according to a preset time interval; and
when the number of times the first control terminal sends the control instruction to each controlled terminal reaches the preset number of times, or the first control terminal does not receive the feedbacked response information of all the controlled terminals within a specified time, sending, by the first control terminal, a preset instruction to each controlled terminal.

10. The cluster control system according to claim 8, wherein sending control instructions to corresponding controlled terminals and/or itself according to the assigned IDs further comprises:
grouping, by the first control terminal, the controlled terminals and itself according to the assigned IDs, and obtaining at least two controlled groups;
selecting a controlled group that needs to perform the action; and
sending a control instruction to each controlled terminal and/or the first control terminal itself in the controlled group that needs to perform the action according to the ID of each controlled terminal and/or the first control terminal itself in the controlled group that needs to perform the action.

11. The cluster control system according to claim 8, wherein sending control instructions to corresponding controlled terminals according to the assigned IDs further comprises:
sending, by the first control terminal, control instructions to the controlled terminals needing to perform specific action according to the assigned IDs;
instructing the controlled terminals needing to perform the specific action to analyze the control instructions, and acquire execution orders in which the specific action is performed; and
instructing the Nth controlled terminal of the controlled terminals needing to perform the specific action to send action execution completion information to the N+1th controlled terminal after the action is completed by the Nth controlled terminal, until the specific action is performed, wherein N is an integer greater than or equal to 1.

12. The cluster control system according to claim 8, wherein before sending control instructions to corresponding controlled terminals according to the assigned IDs, the processor is further configured to:
synchronize the time of each controlled terminal with the time of the first control terminal by using a network time synchronization protocol.

13. The cluster control system according to claim 8, wherein the processor is further configured to:
receive an election activity initiated by a terminal newly joined to the cluster, select a first control terminal of current moment according to the election activity; and
adjust the original first control terminal to be a second control terminal of the current moment, and adjust the original second control terminal to be a controlled terminal.

14. The cluster control system according to claim 8, wherein the processor is further configured to:
periodically send, by the first control terminal, valid status information to the second control terminal, and receive, by the first control terminal, status feedback information sent by the second control terminal; wherein the valid status information is used to identify that the first control terminal is currently in a valid working status;
when the first control terminal does not send the valid status information to the second control terminal within a first preset time period, update the second control terminal to be a first control terminal; and
when the first control terminal does not receive the status feedback information sent by the second control terminal within a second preset time period, initiate an election activity for electing a second control terminal.

15. A terminal device, comprising:
a memory, a processor, and a computer program stored in the memory and executable by the processor; wherein the processor is configured to, when executes the computer program, implement following operations:
assigning, by a first control terminal, cluster IDs to itself and controlled terminals connected to the first control terminal, wherein the controlled terminals comprise at least two controlled terminals, and the controlled terminals comprise a second control terminal; the second control terminal is configured to, when the first control terminal fails, update to be a first control terminal; and
sending, by the first control terminal, control instructions to corresponding controlled terminals and/or itself according to the assigned IDs when the first control terminal receives information feedbacked by all the controlled terminals and itself and denoting that ID assignments succeed, wherein the control instructions are configured to instruct the corresponding controlled terminals and/or the first control terminal itself to perform corresponding actions.

16. The terminal device according to claim 15, wherein sending control instructions to corresponding controlled terminals according to the assigned IDs comprises:
sending, by the first control terminal, a control instruction to each controlled terminal according to the assigned IDs, and receiving, by the first control terminal, response information of each controlled terminal;
when the quantity of the control instructions sent by the first control terminal is greater than the quantity of the received response information, sending, by the first control terminal, a control instruction to each controlled terminal again according to a preset time interval; and
when the number of times the first control terminal sends the control instruction to each controlled terminal reaches the preset number of times, or the first control terminal does not receive the feedbacked response information of all the controlled terminals within a specified time, sending, by the first control terminal, a preset instruction to each controlled terminal.

17. The terminal device according to claim 15, wherein sending control instructions to corresponding controlled terminals and/or itself according to the assigned IDs further comprises:
grouping, by the first control terminal, the controlled terminals and itself according to the assigned IDs, and obtaining at least two controlled groups;
selecting a controlled group that needs to perform the action; and
sending a control instruction to each controlled terminal and/or the first control terminal itself in the controlled group that needs to perform the action according to the ID of each controlled terminal and/or the first control terminal itself in the controlled group that needs to perform the action.

18. The terminal device according to claim 15, wherein sending control instructions to corresponding controlled terminals according to the assigned IDs further comprises:
sending, by the first control terminal, control instructions to the controlled terminals needing to perform specific action according to the assigned IDs;
instructing the controlled terminals needing to perform the specific action to analyze the control instructions, and acquire execution orders in which the specific action is performed; and
instructing the Nth controlled terminal of the controlled terminals needing to perform the specific action to send action execution completion information to the N+1th controlled terminal after the action is completed by the Nth controlled terminal, until the specific action is performed, wherein N is an integer greater than or equal to 1.

19. The terminal device according to claim 15, wherein before sending control instructions to corresponding controlled terminals according to the assigned IDs, the processor is further configured to:
synchronize the time of each controlled terminal with the time of the first control terminal by using a network time synchronization protocol.

20. The terminal device according to claim 15, wherein the processor is further configured to:
receive an election activity initiated by a terminal newly joined to the cluster, select a first control terminal of current moment according to the election activity; and
adjust the original first control terminal to be a second control terminal of the current moment, and adjust the original second control terminal to be a controlled terminal.
